(19) United States
(12) Patent Application Publication
(10) Pub. No.: US 2011/0062741 A1
(43) Pub. Date: Mar. 17, 2011

(54) Palm-like Sun Visor

(76) Inventor: ILO Kristo Xhunga, Avon, OH (US)

(21) Appl. No.: 12/667,422

(22) PCT Filed: Dec. 30, 2009
(86) PCT No.: PCT/US09/69859

§ 371 Date: Dec. 31, 2009

Related U.S. Application Data
(60) Provisional application No. 61/158,454, filed on Mar. 9, 2009.

(51) Int. Cl. B60J 3/00

(52) U.S. Cl. 296/97.2

(57) ABSTRACT

Palm-like sun visor principally working like the upright-extended palm of the hand to protect the eyes from sun glare. It comprises sun visor body (24), retracting unit (40), and bendable arm (36) connecting the sun visor body and the retracting unit mounted on a vehicle's ceiling. Sun visor body (24) is disposed in a recessed location adjacent to the retracting unit and substantially flush with the vehicle's headliner. Bendable arm (36) has a predetermined structure that makes it bendable for winding in the retracting unit and rigid enough for holding sun visor (24) fixed in place. The user pulls the sun visor using two-finger handle (28) and adjusts sun visor body (24) near the windshield or side window for the best sun glare protection. The user activates retracting unit (40) that pulls up the sun visor body. The palm-like sun visor incorporates vanity mirrors.

### TECHNICAL FIELD

The invention relates to sun visors and vanity mirrors mounted inside motor vehicles.

### BACKGROUND ART

The earliest sun visor must have been the upright-extended palm of the hand of the prehistoric human. The palm extended upright protects the eyes from sun glare. Positioning the palm at various distances from the eyes controls the size of the covered area. Besides being handy, the palm visor strikes a good balance between blocking the sun glare and not blocking the view of the road ahead. On the other hand, the palm visor has its drawbacks. It can only be used for short intervals of time during which the user has only one free hand.

Although present-day drivers are inside motor vehicles, they nevertheless encounter dazzling sunrays entering through the windshield and side windows. The need to protect drivers and passengers from sun glare has brought sun visors into vehicles. A sun visor has a sun visor body, which essentially is a rectangular plate, and a pivot rod assembly. The rod assembly has a bold pivot rod of an L-shape, a means for mounting the rod to the vehicle's roof and/or headliner, and a torque control mechanism, which rotationally mounts the visor body to the rod. In some designs, the visor can slide left and right on its rod. The sliding feature increases the coverable area on the windshield, but it also introduces lateral play and flutter while driving. A tighter fit of mating surfaces reduces the play and flutter, but it increases friction and requires a greater force by the user to slide the visor. The sliding force must overcome friction. In order to achieve both, a reduced sliding effort and a suppressed flutter and lateral play, extra mechanisms are required that further complicate the visor and add extra cost.

Conventional sun visors allow gaps between the edge of the visor and the vehicle's pillar, leaving open areas where the sun can enter to the discomfort of the user. There is also an unprotected gap between the driver's and passenger's visors, and furthermore, the entire area underneath both visors is not coverable. Sun glare in the early morning and late afternoon is a serious concern for commuting drivers. Conventional sun visors do not protect commuters from the glaring impact of direct sunrays at low angles above the horizon, and some drivers adjust their travel schedules to avoid peak glare hours. Below-average-height drivers are particularly unprotected with conventional visors; they get the full force of the sun under the visor.

Additional concerns are the glaring sunrays reflected off the hood of a vehicle through the windshield and into the driver's eyes. Overhead visors located against the upper part of the windshield are ineffective for blocking off-the-hood reflections. Extra visors are needed to suppress the hood glare. Some vehicles have them mounted above the dashboard, adjacent to the lower edge of the windshield. They help, but at the price of overcrowding the passenger compartment and of increasing the nomenclature of parts and cost.

Visors known in the art give protection limited to the maximum area of the sun visor body, without covering effectively all the areas requiring protection. Increasing the size of sun visors or adding side extensions obstructs a larger portion of the viewing area and impedes the driver's view through the front windshield. Sun visors are already bulky even without their extensions and compromise safe driving by substantially reducing the driver's view. For example, conventional sun visors can easily block the view of a traffic light signal. The problem is that sun visors of the prior art are limited to only one operating position on the upper part of the windshield and another one on the side window. The two static visor positions are not a match for the continuously changing driving situations. A vehicle does not only travel horizontally, but also uphill and downhill, not only in one direction, but also left and right. Furthermore, as the sun moves across the sky, the glaring sun rays entering the vehicle change their entrance points accordingly. The sun visors do not allow assorted positioning for a proper response to various driving situations. The quasi-static approach of the prior art is inadequate for dynamic driving conditions.

The large size and bulkiness makes sun visors difficult to use. In some situations, the driver has to force the head backwards to make room for rotating the sun visor body from the storage position to the glare-blocking position. Pivoting the sun visor body against the side window requires additional effort by both hands. In some cases the driver has to pull back the whole body by moving the seat backwards before pivoting the bulky sun visor towards the side window. In the event of a crash, occupants are violently moved in relation to the vehicle due to inertial forces. The occupant's head is most vulnerable, as it can impact the bold L-shaped rod of the visor during a collision.

Sun visors usually incorporate a vanity mirror, which generally can be opened only after the visor is rotated as a whole around its rod to a position against the upper part of the windshield. The above rotation around the rod is also the only adjustment available for the mirror. Other rotational angles are unavailable, and the distance of the mirror to the viewer's eyes is unchangeable. Instead of adjusting the mirror as needed for a better view, the user has to adjust the sitting position relative to the mirror, which in some cases might require moving the body up or down, front or back.

As manufacturers introduce new vehicles, customers will appreciate avoiding the above drawbacks with new functional sun visors and vanity mirrors.

### DISCLOSURE OF INVENTION

Embodiments of a palm-like sun visor for motor vehicles are disclosed. The device comprises a visor body, a bendable gooseneck, and a retracting unit. The bendable gooseneck connects the sun visor body with the retracting unit. The gooseneck has a predetermined internal structure that makes it bendable, though with a certain degree of rigidity. While the bending ability makes it woundable in a reel in the retracting unit, its rigidity makes the gooseneck capable of holding the sun visor body fixed in the pulled-out positions. When the sun visor is retracted to the recessed location, the gooseneck is concealed above the ceiling. The sun visor body enters a recessed location and stands substantially flush with the vehicle's headliner. The palm-like sun visor is shaped to be non-protruding, aesthetically-pleasing, and safe in use.

The combination of the three parts makes a sun visor that works like the upright extended palm of the hand to protect the eyes from sun glare. The palm-like sun visor is easily positioned adjacent to the windshield or side window. The user moves it closer to the eyes or further away to find the proper balance of blocking the sun rays without blocking the road view. The user can conveniently pull the palm-like sun visor down with one hand and position it against the windshield or side window. The palm-like sun visor can reach any area adjacent the windshield or side window offering full protection from sun glare. It can also be positioned against the lower edge of the windshield to protect the driver or the front-seat passenger from sun rays reflected off the hood. At night, the user can position the sun visor appropriately to protect the eyes from disturbing lights, such as the headlights of incoming traffic. After use, the palm-like sun visor is retractable out of the user's way into the nonintrusive location on the ceiling. The user activates the retracting unit (for example by pressing a button) which retracts and rewinds the gooseneck, pulling up the sun visor body to its nonintrusive location on the ceiling. As the sun visor approaches the recessed location on the ceiling, the user might adjust the direction of the sun visor slightly, then snap it into the recessed location. The user can easily perform these actions with one hand.

Embodiments of visors shown in the drawings incorporate vanity mirrors, although alternative embodiments may not have mirrors. The user can adjust the direction and position of the visor to find the mirror's best viewing angle and distance. The palm-like sun visor can be installed not only for the front seats, but also for the back seats in vehicles, where it serves as a vanity mirror and sun visor for the side window. Besides their use as vanity mirrors, the mirrors of the visor shown in the drawings can also be used in another function. They can be positioned and oriented properly above the user's head to view the occupants in the back row(s), especially useful for parents with young children in the back seat.

It is contemplated that the palm-like sun visor device be installed as part of a vehicle's original equipment. Retro-fitting used vehicles with palm-like sun visors is also an option for specific types of motor vehicles. Besides automobiles and other road vehicles, the term motor vehicle of this disclosure describes trains, watercraft, and aircraft.

### BRIEF DESCRIPTION OF DRAWINGS

The accompanying drawings in conjunction with the detailed description illustrate embodiments of the invention and explain its principles.

FIG. 1 is the bottom-front perspective view of the palm-like sun visor in its nonintrusive location.

FIG. 2 shows the device with the sun visor in its pulled-down glare-blocking position against the windshield.

FIG. 3 shows the device with the sun visor in its pulled-down glare-blocking position against the left-side window.

FIG. 4 shows the sun visor incorporating vanity mirrors with mirror lids opened completely.

FIG. 5 shows the sun visor mirrors properly positioned for viewing the back seats.

FIG. 6A and FIG. 6B are bottom-front and top-front views of the recessed faceplate and the retracting unit, where the sun visor and the headliner are removed for clarity.

FIG. 7A and FIG. 7B are bottom-front and top-front views of the sun visor and the retracting unit, with the recessed faceplate, headliner, and lid of the retracting unit removed for clarity.

FIG. 8 is a close-up internal view of the retracting unit.

FIG. 9 is a close-up internal view of the reel (the upper side of the reel is removed for visibility).

FIG. 10A and FIG. 10B are close-up views at two different viewing angles of the rod, wheels, and press button of the lock-and-release mechanism.

FIG. 11A and FIG. 11B are cut-away views of the lock-and-release mechanism in the locking position and in the release position, respectively.

FIG. 12 is a cut-away back-view of the central part of the sun visor body.

FIG. 13A and FIG. 13B are close-up views of the pivotal connector and the mounting plate.

FIG. 14 is a close-up view of a section of the gooseneck showing its double-coil structure.

FIG. 15 shows the power spring mounted on the arbor.

### THE BEST MODES FOR CARRYING OUT THE INVENTION

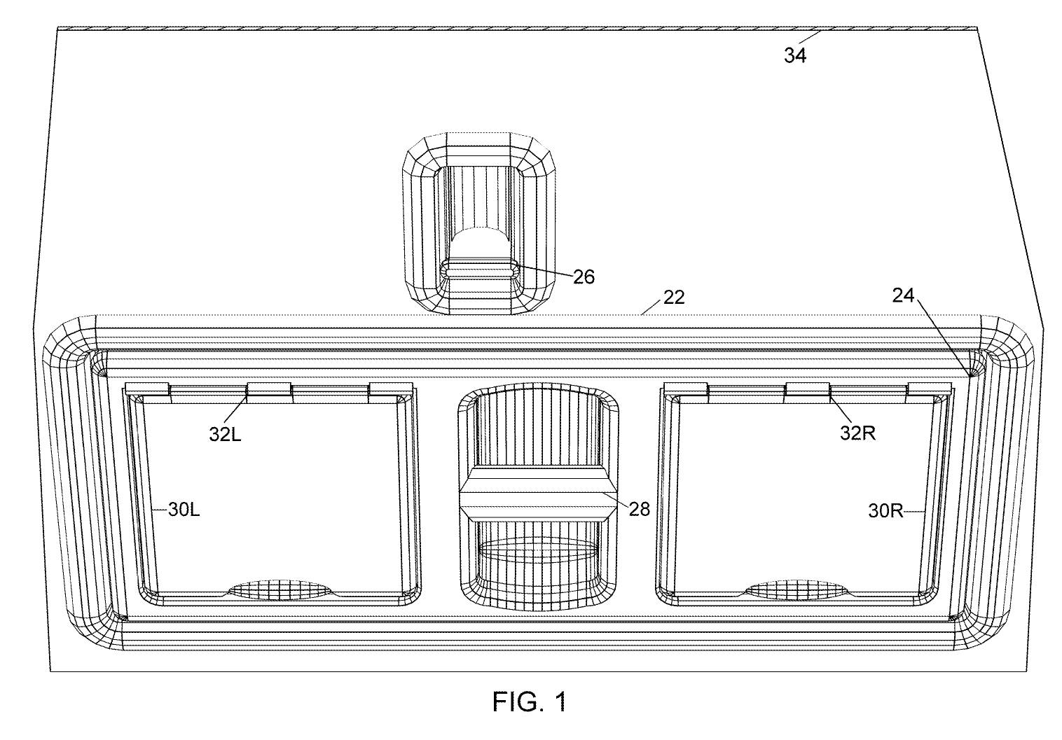

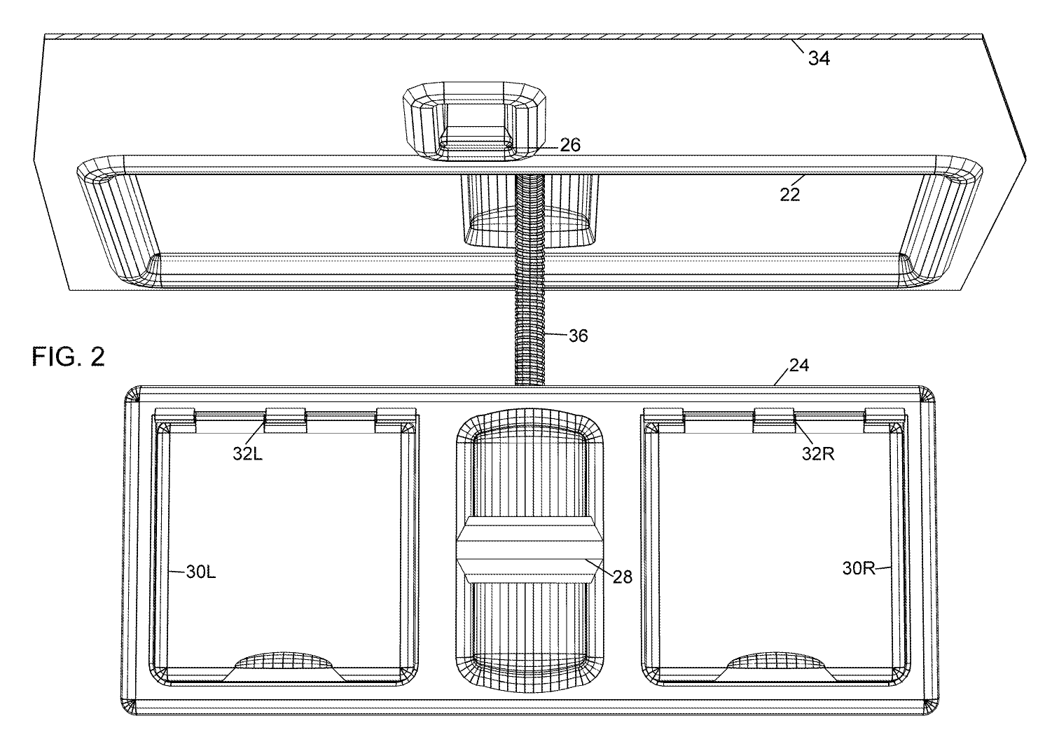

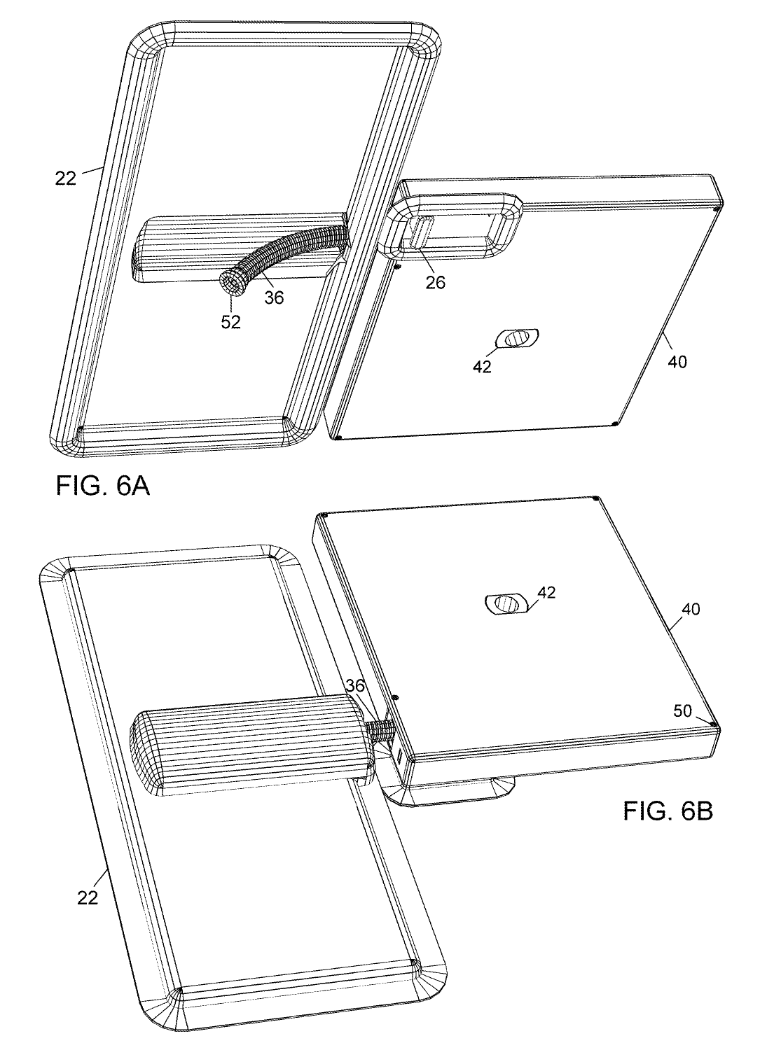

The first five figures, FIG. 1 through FIG. 5, show the palm-like sun visor device as a whole. FIG. 1 shows the device in its nonintrusive location on the vehicle's roof, while FIGS. 2 through 5 show the sun visor in its four main functioning positions. In FIG. 1, recessed faceplate 22 is installed on headliner 34 and reinforced into the roof frame (not shown) of the vehicle. Sun visor 24 and press button 26 are shown on the surface of recessed faceplate 22. Sun visor 24 has snapped-in onto recessed faceplate 22. Two-finger handle 28 at the center of sun visor 24 serves to pull down the sun visor into various functioning positions. The user can pull down sun visor 24 directly, without pressing any buttons. Button 26 activates the automatic pull-up of sun visor 24 by retracting unit 40 (shown in FIG. 6A through FIG. 8) disposed behind headliner 34.

### Sun Visor Unit

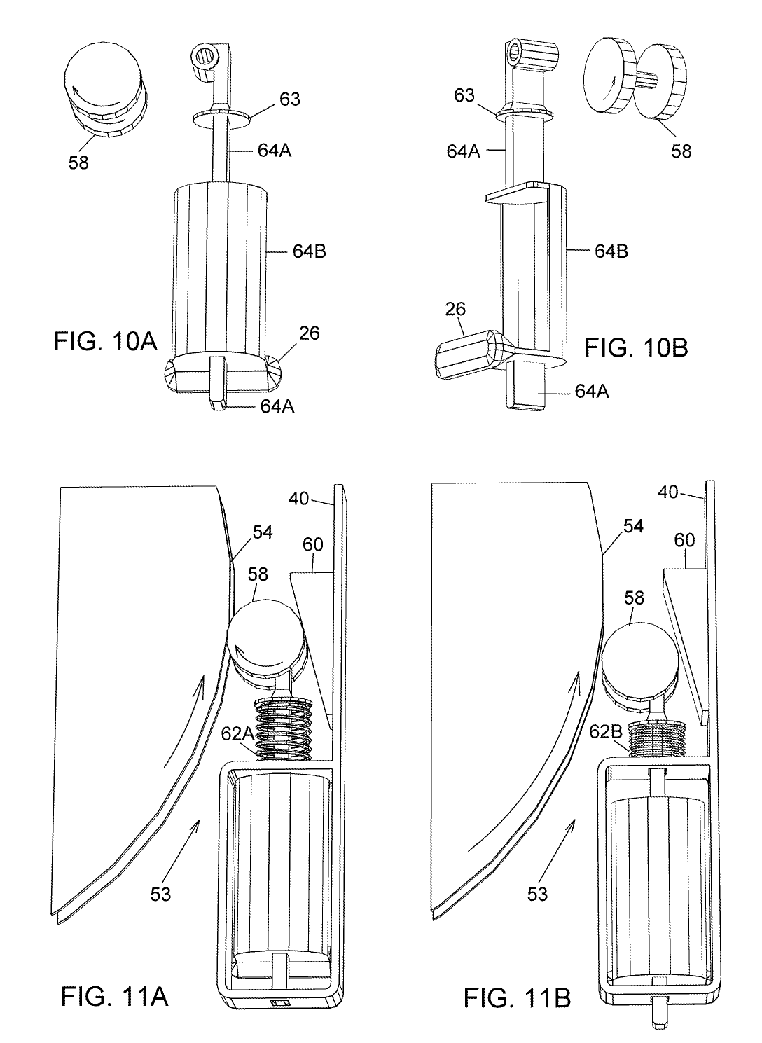

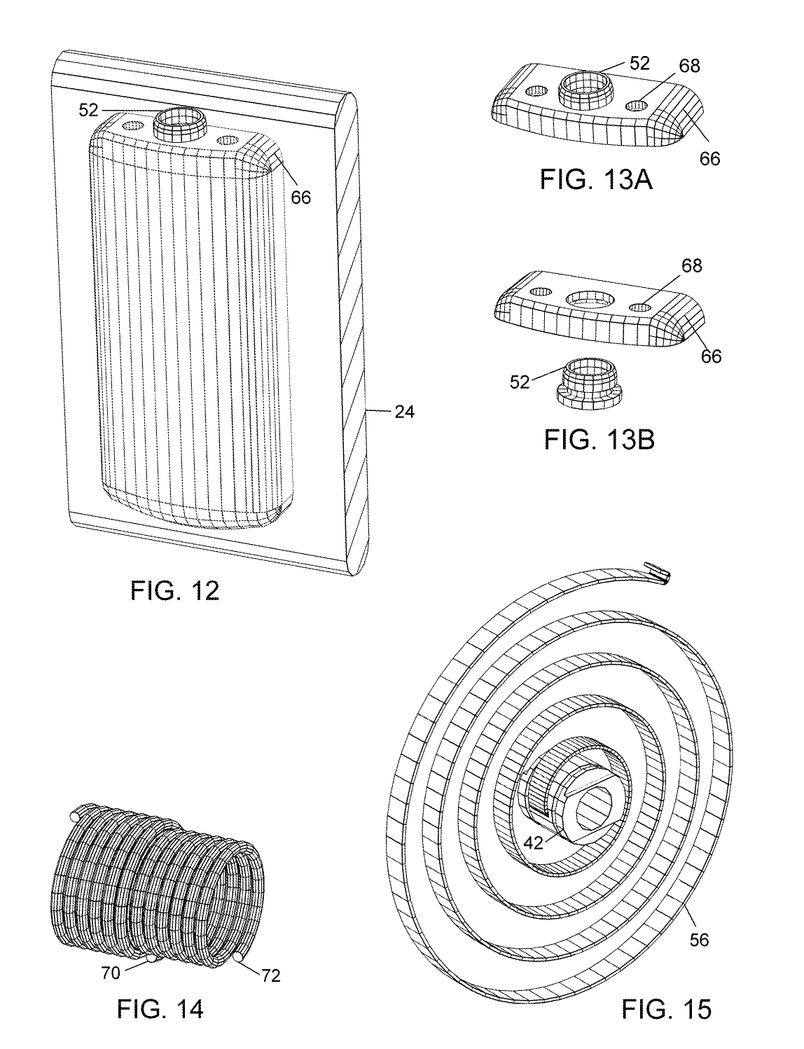

In the exemplifying embodiment, sun visor 24 has a pivotal connection with gooseneck 36 on the upper-back side. Mounting plate 66 is fastened to the sun visor body by two screws through screwing holes 68 (FIGS. 12, 13A, and 13B). Gooseneck connector 52 is pivotally attached to mounting plate 66. The user can rotate the sun visor at any angle with respect to the gooseneck. Frictional forces between surfaces in contact are usually sufficient to hold the given orientation. Nevertheless, to better preserve the orientation, a compression spring (not shown in this embodiment) is added between connecter 52 and plate 66. Rotation-resist springs are well known in the art.

As shown in the exemplifying embodiments, sun visor 24 incorporates two vanity mirrors covered by lids 30L and 30R. Hinges 32L and 32R allow the lids to be opened at different angles up to 180 degrees. FIG. 2 shows sun visor 24 pulled down by the user in the glare-blocking position against the windshield. Bendable arm or gooseneck 36 holds the sun visor 24 in position, until the user finds it necessary to adjust the visor as the orientation of the vehicle changes on the road. Sun visor 24 can be moved in any of the three directions, left or right, up or down, and closer to or away from the user. Two-finger handle 28 positioned in the middle part of the sun visor makes position adjustments easy and convenient.

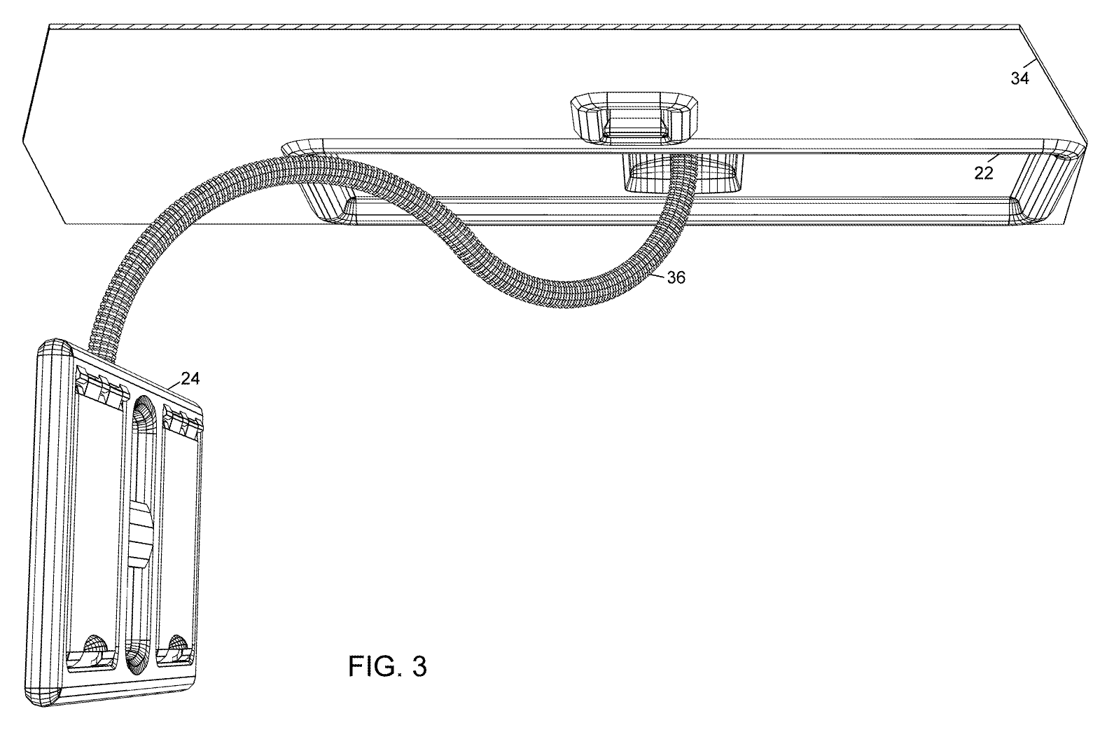

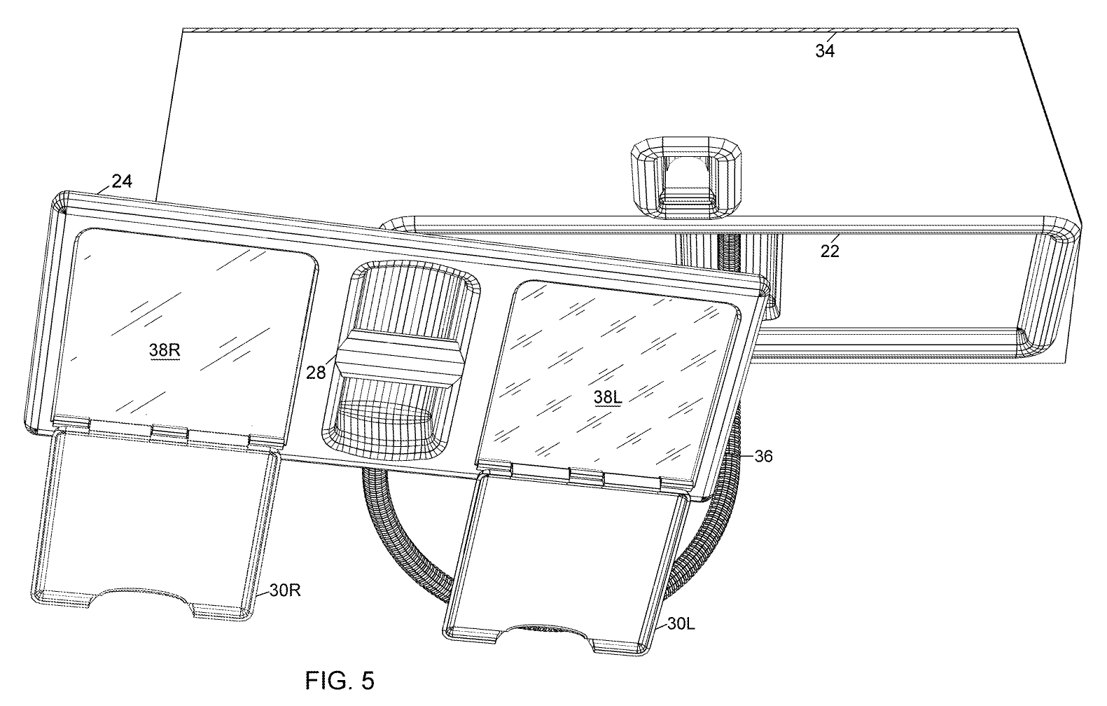

FIG. 3 shows sun visor 24 positioned to the left of the user in the glare-blocking location against the side window. Gooseneck 36 is first pulled down, then pushed up and to the side of window, taking the bendable form of the drawing in FIG. 3. Gooseneck 36 can take other bendable forms to block sun glare from a side window. The gooseneck, for example, can be bent in the form of a “u” turn, like the one shown in FIG. 5. Making a single turn requires less bending of the gooseneck. The sun visor's resulting orientation is the reverse of the one shown in FIG. 3.

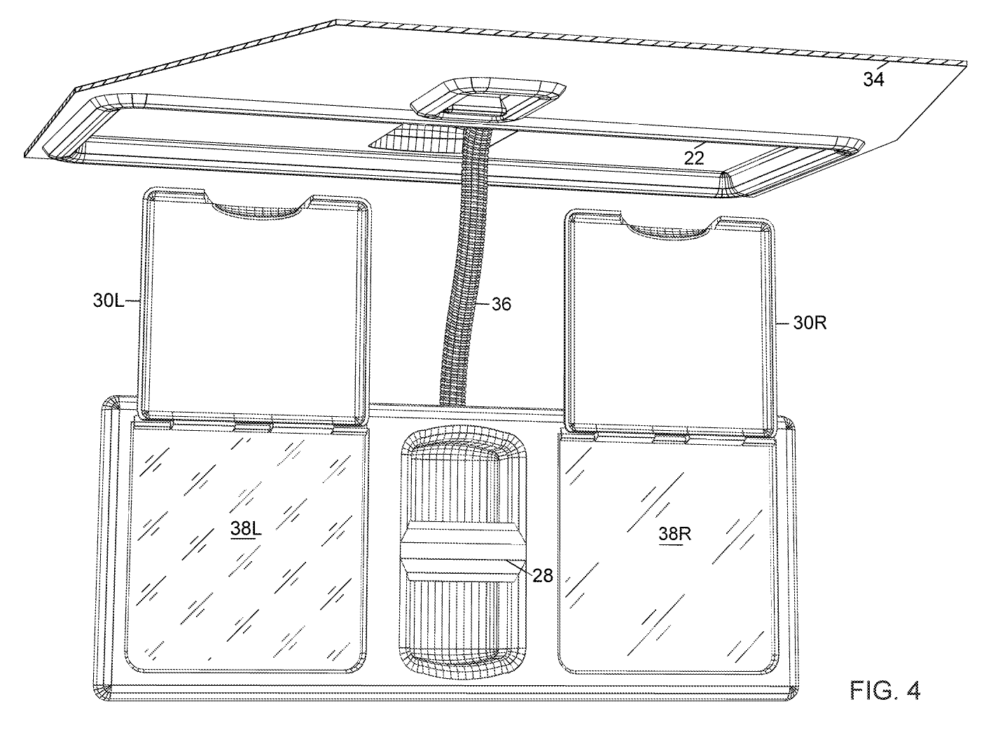

FIG. 4 shows sun visor 24 with both incorporated mirrors opened. Gooseneck 36 is pulled down to a suitable height and pushed forward, as necessary, to adjust the distance from the mirror to the eye for the best view. In this figure, the pulled-out part of the gooseneck has taken the shape of a stretched letter “s”. Lids 30L and 30R are opened at 180 degrees, as shown in FIG. 4, but they may also be opened at smaller angles. Lids are lightweight and the frictional forces of the hinges are large enough to hold the lids stable at any position. Mirrors of different embodiments can vary according to customer preferences. One mirror may be natural size, while others may have magnification in the order of 2×, 3×, etc.

In another variation, mirrors can be both straight (without magnification), but turned at a small angle towards each other for a better back-seat view. Sun visor 24 first is pulled down, then pushed up and rotated while gooseneck 36 is bent in a “u” turn, as shown in FIG. 5. Mirrors are opened and the user can keep an eye on the back seats without having to turn the head backwards. The sun visor is raised higher than the user's head, so that the user can see the back row of seats. The mirror view may help in carrying a conversation, attending a child playing in the back seat, or watching an older/sick relative, etc. This is an extra use that adds to the functionality of the palm-like sun visor when it is not being used in its glare-blocking position.

In another embodiment, not shown in the figures, both sun-visor mirrors are made modular. The mirrors can be snapped in and out easily. These snap-in mirrors are mounted and removed by the user. When driving, some users may want the option of removing mirrors and keeping a feather-light sun visor in its pure function of blocking glare.

Plastic, carbon fiber, carbon composite or similar materials can be used to make sun visor 24. Safety reasons do not mandate the use of a soft cloth cover on the visor when lightweight and shock-tolerant materials are chosen in its manufacturing. After all, the sun visor will be mounted on a bendable shock-dampening gooseneck.

### Bendable Arm, Gooseneck Unit

Gooseneck 36 is one of the three main units of the palm-like sun visor. It is a bendable elongated arm. While being bendable by a user, the gooseneck is rigid enough to hold the weight of a light sun visor connected at one end. Its internal structure has two coils of densely wound wire. The inner surface of the larger coil is in touch with the outer surface of the smaller coil, enclosing the latter. Fractions of two enlarged gooseneck coils are shown in FIG. 14, where coil 70 embraces coil 72. The gooseneck is finished with a plastic or rubber coating.

A coil has bendability and elasticity. It easily bends and returns back to its initial shape once the bending force is removed. The single coil does not preserve its bended shape. It is elastic.

The two-coil structure eliminates the single-coil elasticity and creates a bendable gooseneck that preserves its given form. Internal forces of static friction at points of contact between the outer surface of smaller coil 72 and the inner surface of larger coil 70 do not allow coil surfaces to slide. Without surfaces sliding, a bent two-coil gooseneck will not return to its previous form. Forces of static friction will preserve the gooseneck's new form indefinitely. The gooseneck gains rigidity due to static friction and retains its shape. To force the gooseneck into changing form again, the bending effort of the user's hand or the bending torque of the retracting unit is required.

Furthermore, a gooseneck with a certain degree of rigidity can hold a moderate amount of weight at one end and still preserve its given form. The combination of two coils gives the gooseneck a holding capacity. The more rigid a gooseneck is, the more weight it can hold. Its rigidity is determined by its coil diameters, clearance gaps between coils, coil winding directions, type of coil wire, wire thickness, etc. Various degrees of rigidity are obtained by manipulating the above factors.

The chosen gooseneck must be bendable enough for winding in the retracting unit, and rigid enough for holding the sun visor at a fixed position.

Another consideration is the lateral displacement of the sun visor from its hanging point. Any bendable gooseneck can hold a sun visor at a position directly below the hanging point. However, the more lateral displacement required, the more rigid the gooseneck must be.

Once the weight and the lateral displacement of the sun visor are known, a gooseneck with a specific bendability and rigidity is selected. The main function of the sun visor is to protect the user from sun glare. Fortunately, a sun visor does not have to be heavyweight to block sunrays. Even a feather light sun visor can still stop sunrays equally well. This is advantageous in designing the palm-like sun visor device. The gooseneck can also be lightweight, small in thickness, and easily woundable in the reel. The retracting unit can also be small in thickness and light in weight.

Goosenecks are available from gooseneck-manufacturing companies that accept customer-specific orders. After the load and lateral displacement are specified by the customer, a manufacturer comes up with an offer that specifies the thickness, bending limit, and other characteristics of the gooseneck. The bending limit is defined as the smallest radius of curvature that the gooseneck can tolerate at bending. Some companies publish tables that show characteristics of their goosenecks versus the load and lateral displacement. The higher the quality of the gooseneck, the lighter the gooseneck and the smaller its bending radius and its thickness.

### Retracting Unit

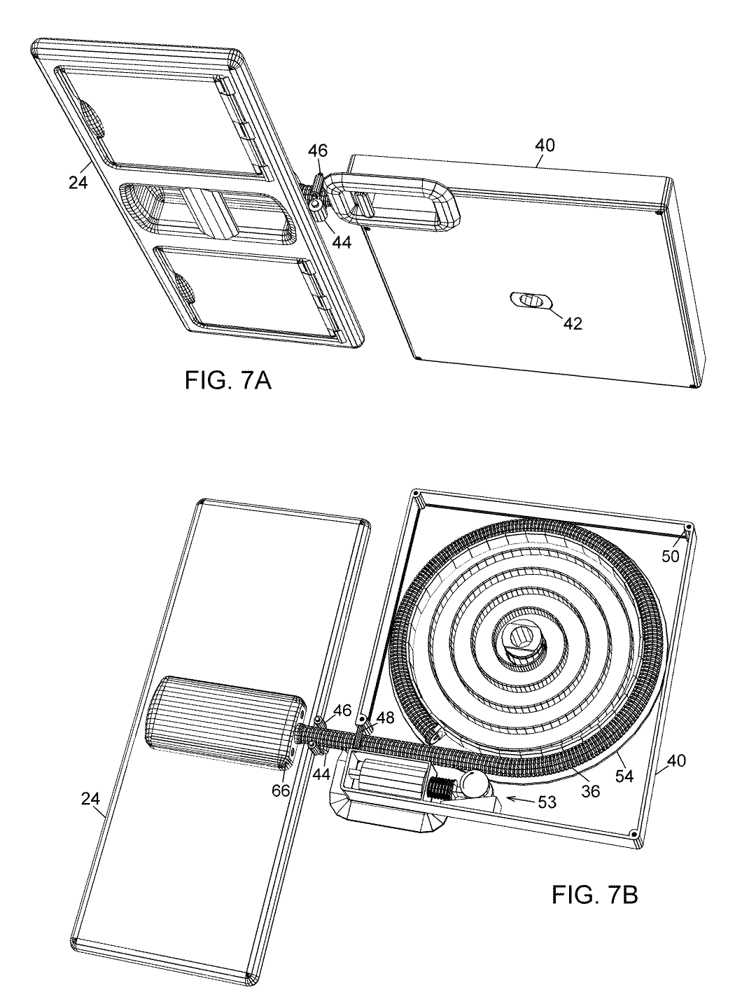

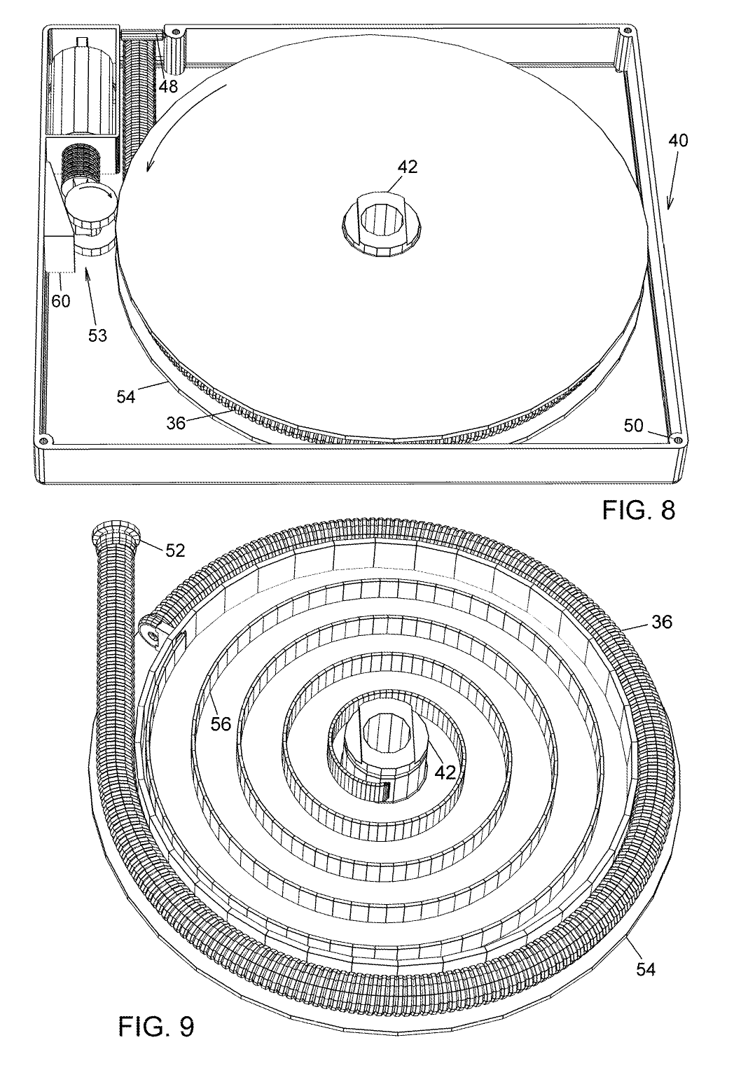

Retracting unit 40 houses reel 54 and lock-and-release mechanism 53 (FIG. 7B and FIG. 8). Reel 54 is urged by power spring 56, which exerts a continuous pulling torque. Its rotational tendency is always towards winding the gooseneck back into the reel, retracting sun visor 24 to its nonintrusive location. Power spring 56 is mounted on arbor 42 at one end (FIG. 15) and on the base of reel 54 at the other one (FIG. 9). Power spring 56, which is also known as a spiral spring or clock spring, is similar to springs used in applications such as cable-retracting reels, tape measures, and retracting seat belts.

Rod 64A holds the moving parts of lock-and-release mechanism 53. Stopper wheel 58 is mounted rotationally on the cylindrical hole of rod 64A (FIGS. 10A and 10B). Rod 64A has a bulging part 64B to accommodate the user's finger for pressing button 26. Rod 64A has also a disk 63 that presses on one side against button spring 62A. The other side of button spring 62A is pressed against and fixed to the frame of retracting unit 40. As shown in FIGS. 10A and 10B, rod 64A slides inside two holes cut on the walls of retracting unit 40 when button 26 is pressed.

Lock-and-release mechanism 53 blocks reel 54 from rolling back, allowing the sun visor to stay indefinitely fixed in any pulled-down position, until further action is taken.

FIGS. 11A and 11B are cut-away views of retracting unit 40, showing the operation of lock-and-release mechanism 53 in its two different states. Spring 62A is relaxed in FIG. 11A, whereas spring 62B is contracted in FIG. 11B as the user presses button 26.

In the first or normal state, reel 54 is shown to have a permanent tendency to rotate in the arrow direction driven by power spring 56 inside the reel. Stopper wheel 58 starts to rotate in the direction of the arrow shown on its surface, moving towards the narrowing gap between the rim of reel 54 and friction pad 60. As a result, the rotation of reel 54 is locked by frictional forces created on pressed surfaces.

In the second state, button 26 is pressed, stopper wheel 58 moves away from the gap and releases reel 54, which starts rotating driven by power spring 56 inside the reel, rewinding the gooseneck back and pulling the sun visor towards the nonintrusive location. Curved arrows show the directions of rotational tendencies for reel 54 and stopper wheel 58. The larger curved arrow in FIG. 11B depicts the rotation of reel 54 once button 26 is pressed. When button 26 is released, spring 62B expands into the shape of spring 62A, and stopper wheel 58 blocks further rotation.

In summary, lock-and-release mechanism 53 allows and blocks the rotation of reel 54 under the control of button 26, while power spring 56 inside the reel continuously keeps urging its rotation in one direction.

The reader may have already noticed that lock-and-release mechanism 53 does not interfere with the pulling of sun visor 24 by the user. In such a case, reel 54 and stopper wheel 58 rotations are the reverse of those shown in the figures, and the stopper wheel moves away from the narrow gap allowing the reel to rotate unimpeded. The user can pull the sun visor from any intermediary position without pressing the button. However, the pulling force of the user must overcome the winding torque of power spring 56. This is barely a challenge because the user's pulling force is applied downwards. The weight of the hand is applied when pulling downwards, making the pull of the sun visor easy and convenient.

### Operation

The palm-like sun visor device can be pulled out directly with one hand. Two-finger handle 28 is sized to fit the pointer finger and the middle finger around the handle. The thumb in the front part of the handle helps to grip it comfortably and pull or push it as needed. There is no need to press any button when pulling down or manipulating the sun visor for position adjustment.

The pivotal connection of sun visor 24 with gooseneck 36 allows full-circle rotation around the gooseneck. The combination of pivotal connection and gooseneck bendability gives the user three-dimensional control over sun visor's orientation and positioning.

The sun visor is pulled in its nonintrusive location when the user presses button 26. The user presses the button in the horizontal direction forward with one finger. Reel 54 unlocks and starts rotating, urged by the torque of power spring 56 inside retracting unit 40. Gooseneck 36 is wound back into the retracting unit, as the sun visor is pulled up. The user can stop and resume the visor retraction at any intermediary position by releasing and repressing the button repeatedly.

When sun visor 24 approaches recessed faceplate 22, the user gives it a slight orientation with one hand and snaps it in its nonintrusive location on the recessed faceplate. All operations involve only the fingers of one hand and can be performed easily by the user while driving.

### INDUSTRIAL APPLICABILITY

The palm-like sun visor can be installed for the front seats, but also for the back seats in vehicles, where it serves as a vanity mirror and sun visor for the side windows. It can be installed as part of a vehicle's original equipment. Retro-fitting used vehicles with palm-like sun visors is also an option for specific types of motor vehicles.

### OTHER EMBODIMENTS

Other embodiments and variations of the device, similar to the ones that follow, are expected in the spirit and scope of this invention. Three main units comprise this invention, the visor body, the bendable gooseneck, and the retracting unit. That said, each unit is expected to have many internal variations. For example:

Sun visor 24 can have various shapes, such as rectangular, oval, or other aesthetically pleasing forms. It can be manufactured using various light materials, such as plastic, hard rubber, carbon fiber, carbon composite and others, which are well known to those of ordinary skill in the art.

In other embodiments, not shown in the figures, both mirrors 38 can be made modular. The user would have the freedom to remove and replace the mirrors at will. When driving, some users can have the option of removing mirrors and keeping the feather-light sun visor in its primary function as a glare-blocking device.

In yet other embodiments, the sun visor for the driver seat can be designed to be modular and without mirrors. Sun visors without mirrors are lighter and can be positioned more remotely from the hanging point than sun visors with mirrors. Some drivers may like the option of replacing the sun visors with mirrors with feather-light visors without mirrors for certain driving conditions.

Two-finger handle 28 may be installed in other parts of the sun visor instead of at its center. The handle, for example, can be located at the bottom of the sun visor, and have different forms. Hinges 32L and 32R can be moved to the side or at the bottom of lids 30L and 30R.

Gooseneck 36 comprises two wire-wound coils and a soft coating. Arrangements and characteristics of coils and coatings can vary in broad ranges, as previously described, to provide the proper balance of gooseneck bending ability and rigidity that is required to handle the sun visor weight and its lateral displacement. Other gooseneck designs might employ different numbers of coils, or no coils, various coil materials, and various plastic, rubber, or other coatings. Future gooseneck structures may have uniform or varying distributions of tiny elastic and rigid elements instead of having two coils, quite different and more advanced than those employing the two-coil structure.

Instead of winding reel 54, an elongated power spring can be employed to retract the gooseneck without winding it. Instead of being supported on recessed faceplate 22, the sun visor and the retracting unit can be mounted directly on the ceiling headliner, or on the vehicle's frame and its inclosing shell. Power spring 36 that drives retracting unit 40 can be replaced with an electric motor.

Instead of lock-and-release mechanism 53 described in the specification, other mechanical mechanisms like those used for controlling cable winding reels, safety belts or tape measures can be employed. Some lock-and-release mechanisms are activated by pulling down the cable with a short jolt, eliminating the need for a press button to activate the retracting unit. They are all well known to those of ordinary skill in the art and can be employed as well. Instead of mechanical lock-and-release mechanism 53, an electro-mechanical equivalent that employs a ferromagnetic relay and an electric switch is also a known replacement in the art. Additional features, well known in the art, can be attached to retracting unit 40, such as a constant pulling torque mechanism, constant speed mechanism, or both. Furthermore, in some applications, for example in small vehicles in which space is tight, light sources can be installed on sun visor 24. In that case, retracting unit 40 may be equipped, for example, with sliding contacts (well known to one skilled in the art) for electrical connections. Gooseneck 36 can serve as a conduit channel for a pair of wires to feed LED sources, for example, that can be installed around the mirrors on the sun visor. Variations within each unit, additions of extra parts, as well as variations of their relative positioning and attachments to the ceiling frame, and/or the vehicle's headliner, are within the spirit and scope of this invention.

### Special Technical Features

In situations when sun glare disturbs the eyes, a person almost by instinct raises a hand upright making with it a functional palm visor. The palm of the hand can be moved further or closer to the eyes, left or right, and up or down. The person finds naturally the best position of the palm to protect the eyes without blocking the view of the road ahead.

The palm-like sun visor of this invention has the features and all the advantages of the human palm visor, and some more—it never becomes tired and always lets the user with both hands free.

The bendable, flexible, light, and retractable gooseneck is one of the distinct features. This feature is in sharp contrast with the rigid, bulky, heavy, L-shaped rod of the quasi-static sun visor of the prior art.

Another special technical feature is the retracting unit. This feature makes the visor nonintrusive. After being used, the palm-like sun visor is automatically pulled out of the way and stowed on the vehicle's ceiling in a nonintrusive aesthetically-pleasing position where the visor body is flush with the vehicle's headliner. The reader can compare it with the sun visors of the prior art which have the bulky visor body and the L-shaped rod protruding into the headroom zone of the user.

Yet another technical feature is the two-finger handle. The handle does not protrude below the visor body. This makes it safe in case it is accidentally hit by the hand or head of the user. This feature also makes contrast with sun visors of the prior art that do not have a handle, and the user is expected to find a way to position somehow the hand(s) on the visor's body to move the visor.

Another technical feature is the size of the sun visor body with a front area that is up to four times smaller compared to that of the prior-art visors. The aforementioned features make the palm-like sun visor highly dynamic and easy adjustable. The three-dimensional positioning and orientation create a palm-like sun visor capable of glare protection at significantly reduced body size. The reduction in size results from the assorted positioning. In contrast, the prior-art sun visors are quasi-static and, as a consequence, large in size.

Materials used in making the body of the visor and the gooseneck are light in weight, relatively soft, and unbreakable. That makes the visor harmless in the event of a vehicle crash. In a front crash, the palm-like visor body will move forward towards the windshield and away from the driver. It actually protects the driver's head from hitting directly the windshield. In an accident where the vehicle is smashed from behind by another vehicle, both the palm-like sun visor and the occupant's head will move backwards. The palm-like sun visor is safe in any driving situation.

Being small in size, being light in weight, being mounted on a light and bendable gooseneck, and having no rod—these are features that make the palm-like sun visor principally superior to sun visors of the prior art.

### ADVANTAGES

The palm-like sun visor protects the user from sun glare entering the vehicle from any point or direction. By changing the sun visor's distance to the viewer's eyes, the covered area on the windshield becomes larger or smaller. This allows the user to find the proper distance at which sun glare is blocked while visibility is preserved. Moving the sun visor further down protects the eyes from off-the-hood glare, eliminating the need for extra dashboard visors. Besides protecting from sun glare at daytime, the visor can be properly positioned against the windshield at night to protect the eyes from other disturbing lights, such as the headlights of incoming traffic. The surface area of the palm-like visor body is up to one quarter of the size of the prior art visors. The palm-like sun visor is considerably lighter in weight compared to other sun visors, which employ bold heavy rods.

The absence of the rod and the smaller overall size make the palm-like sun visor feather-light. The palm-like sun visor can also be installed for the back seats of vehicles, serving both as a vanity mirror and as a sun visor for the side windows. The palm-like sun visor is nonintrusive. It stores its retracting unit and other parts behind the ceiling, exposing only the sides of the recessed faceplate and sun visor bottom part in an aesthetically pleasing view that blends with vehicle's headliner.

The sun visor of the exemplifying embodiments incorporates vanity mirrors. The user can adjust the distance to the eye and change the mirrors' orientation in the three directions to achieve the best views of the face. The mirrors of the sun visor have also an additional function. They can be positioned and oriented properly in front of and slightly above the user's head to view the occupants on the back row seats for having a face-to-face conversation or to watch somebody that needs attendance. This works well not only for the front row seats but also for the intermediary rows in vehicles with more than two seating rows.

Thus, the scope of the embodiments should be determined by the appended claims and their legal equivalents, rather than by the examples given.

What is claimed is:

1. A palm-like sun visor mounted on the ceiling of motor vehicles comprising:
a sun visor body with a handle for pulling out and repositioning said sun visor body with one hand, said sun visor body being disposed substantially flush with the vehicle's headliner in a recessed location on said ceiling,
a retracting unit mounted on said ceiling adjacent to said recessed location, said retracting unit comprising a winding reel, a power spring, a lock-and-release mechanism,
a bendable arm having a first end and a second end, said bendable arm being connected at said first end to said sun visor body and at said second end to said retracting unit,
whereby said bendable arm is wound inside said retracting unit,
whereby a user can pull out said sun visor body from said recessed location to a glare-blocking position against the vehicle's windshield or side window,
whereby said bendable arm holds said sun visor body fixed in place in said glare-blocking position,
whereby the user can activate said retracting unit, which then retracts said sun visor body to said recessed location.

2. The palm-like sun visor of claim 1, wherein said recessed location is a recessed faceplate mounted substantially flush with said vehicle's headliner.

3. The palm-like sun visor of claim 1, wherein said handle for pulling out and repositioning said sun visor body is a two-finger handle mounted in the center of said sun visor body.

4. The palm-like sun visor of claim 1, further including a pivotal connection of said sun visor body with said bendable arm.

5. The palm-like sun visor of claim 1, further incorporating one or more minors mounted on said sun visor body.

6. The palm-like sun visor of claim 5, wherein at least one of said mirrors mounted on said sun visor body is a magnifying mirror.

7. The palm-like sun visor of claim 5, further including at least one light source mounted on said sun visor body, a pair of wires running inside said bendable arm, a pair of sliding electric contacts, and an electric on/off switch that controls the power connection to the vehicle's electric system.

8. A palm-like sun visor mounted on the ceiling of motor vehicles comprising:
a sun visor body with gripping means for pulling out and repositioning said sun visor body with one hand, said sun visor body being disposed substantially flush with the vehicle's headliner in a recessed location on said ceiling,
a retracting unit mounted on said ceiling adjacent to said recessed location, said retracting unit having an urging means for retracting said sun visor body, and a lock-and-release means for activating said retracting unit by the user,
a bendable arm having a first end and a second end, said bendable arm being connected at said first end to said sun visor body, and at said second end to said retracting unit,
whereby said bendable arm is retracted and concealed inside said retracting unit,
whereby a user can pull out said sun visor body from said recessed location to a glare-blocking position against the vehicle's windshield or side window,
whereby said bendable arm holds said sun visor body fixed in place in said glare-blocking position,
whereby the user can activate said retracting unit, which then retracts said sun visor body to said recessed location.

9. The palm-like sun visor of claim 8, wherein said gripping means for pulling down and repositioning said sun visor is a two-finger handle.

10. The palm-like sun visor of claim 8, further including a pivotal connection of said sun visor body with said bendable arm.

11. The palm-like sun visor of claim 8, further including a reel in said retracting unit for winding said bendable arm.

12. The palm-like sun visor of claim 8, wherein said urging means is a power spring that rotates said reel winding said bendable arm on said reel.

13. The palm-like sun visor of claim 8, wherein said urging means is a compression coil spring which pulls said bendable arm to said retracting unit without winding it.

14. The palm-like sun visor of claim 8, wherein said urging means is an electric motor connected to the vehicle's electric system.

15. The palm-like sun visor of claim 8, further incorporating one or more mirrors mounted on said sun visor body.

16. The palm-like sun visor of claim 15, wherein at least one of said mirrors mounted on said sun visor body is a magnifying mirror.

17. The palm-like sun visor of claim 15, further including at least one light source mounted on said sun visor body, a pair of wires running inside said bendable arm, a pair of sliding electric contacts, and an electric on/off switch that controls the power connection to the vehicle's electric system.

18. A method of sun glare protection for motor-vehicle occupants comprising:
providing a sun visor body with gripping means for pulling down with one hand and repositioning said sun visor body, said sun visor body being disposed on a vehicle's ceiling in a recessed location and substantially flush with the vehicle's headliner,
providing a retracting unit mounted on the vehicle's ceiling and adjacent to said recessed location, said retracting unit having an urging means and a lock-and-release mechanism activated by the user,
providing a bendable arm having a first end and a second end, said bendable arm being connected at said first end to said sun visor body, and at said second end to said retracting unit,
pulling down said sun visor from said recessed location to a glare-blocking position against the vehicle's windshield or side window,
having said bendable arm hold said sun visor body fixed in place in said glare-blocking position,
activating said retracting unit for pulling said sun visor body to said recessed location while concealing said bendable arm inside said retracting unit.
